(19) United States
(12) Patent Application Publication
(10) Pub. No.: US 2026/0229950 A1
(43) Pub. Date: Aug. 6, 2026

(54) ELECTRIC SUBMERSIBLE PUMP HOUSING WITH TORQUE-RESISTING FEATURE

(71) Applicant: Halliburton Energy Services, Inc., Houston, TX (US)

(72) Inventors: Philip Ekins, Frimley (GB); Michael Rimmer, Frimley (GB); Hassan Mansir, Frimley (GB)

(21) Appl. No.: 19/042,420

(22) Filed: Jan. 31, 2025

(51) Int. Cl. H02K 5/132; E21B 17/042; E21B 43/12; F04D 13/10; F04D 29/42; F04D 29/62; H02K 15/14

(52) U.S. Cl. CPC H02K 5/132; E21B 17/042; E21B 43/128; F04D 13/10; F04D 29/4293; F04D 29/628; H02K 15/14

(57) ABSTRACT

A motor for an electric submersible pump includes a rotor, a stator concentrically disposed around the rotor, and a main housing including a first lip having first threads. The main housing encloses a portion of the stator. The motor further includes a first extension housing including a second lip having second threads. The first threads engage the second threads to mate the first extension housing to the main housing. A first recess is formed in the main housing and the first extension housing at an interface between the main housing and the first extension housing. The motor further includes a first insert disposed in the first recess.

### BACKGROUND

In electric submersible pumps, motor housings may be required to resist torque applied from operation of the system or from external factors. Mechanical connections made between components that are threaded may not be able to fully resist such torque levels, particularly if the torque acts in a direction to undo the threads. Welding, brazing, or bonding the housings directly together can make re-opening the connection for repair for example, difficult due to the lasting and perhaps damaging effect of the removal process. A process that uses heat to fix the connection may also adversely affect the straightness of the connection, which may impact the run life of the equipment. Straightness of the connection itself due to manufacturing tolerances can be problematic if too much reliance is placed on the threads. The system and method of the present disclosure may address one or more these issues.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic diagram of an electric submersible pump, according to an embodiment of the present disclosure;

FIG. 2 is a perspective view of a motor assembly of the electric submersible pump, according to an embodiment;

FIG. 3 is a perspective cross sectional view of a portion of the motor assembly, according to the embodiment of FIG. 2;

FIG. 4 is a perspective cross sectional view of a portion of the motor assembly, according to the embodiment of FIG. 2;

FIG. 5 is a perspective view of a portion of the motor assembly, according to the embodiment of FIG. 2;

FIG. 6A is a perspective view of the main housing and the extension housings, according to an embodiment;

FIG. 6B is a side view of the main housing and the extension housings, according to the embodiment of FIG. 6A;

FIG. 6C is a perspective cross sectional view of the main housing and the extension housings, according to the embodiment of FIG. 6A;

FIG. 7A1 is a side view of the main housing and the extension housing with an ovular recess, according to an embodiment;

FIG. 7A2 is a perspective cross sectional cutaway view of the main housing and the extension housing with the ovular recess, according to the embodiment of FIG. 7A1;

FIG. 7B1 is a side view of the main housing and the extension housing with a circular recess, according to an embodiment;

FIG. 7B2 is a perspective cross sectional view of the main housing and the extension housing with the circular recess, according to the embodiment of FIG. 7B1;

FIG. 7C1 is a side view of the main housing and the extension housing with a rectangular recess, according to an embodiment;

FIG. 7C2 is a perspective cross sectional view of the main housing and the extension housing with the rectangular recess, according to the embodiment of FIG. 7C1;

FIG. 7D1 is a side view of the main housing and the extension housing with a triangular recess, according to an embodiment;

FIG. 7D2 is a perspective cross sectional view of the main housing and the extension housing with the triangular recess, according to the embodiment of FIG. 7D1;

FIG. 8A is a side view of the main housing and the extension housing with an off-center recess towards the extension housing, according to an embodiment;

FIG. 8B is a side view of the main housing and the extension housing with an on-center recess, according to an embodiment;

FIG. 8C is a side view of the main housing and the extension housing with an off-center recess towards the main housing, according to an embodiment;

FIG. 9A is a perspective cross sectional cutaway view of a main housing an extension housing with a pilot hole in the insert, according to an embodiment;

FIG. 9B is a cross sectional side view of a portion of the main housing and the extension housing with the pilot hole in the insert according to the embodiment of FIG. 9A;

FIG. 10 is a perspective cross sectional cutaway view of a main housing and an extension housing with multiple recesses and inserts, according to an embodiment;

FIG. 11A is a perspective view of the main housing and the extension housing with a weld between the insert and the extension housing, according to an embodiment;

FIG. 11B is a perspective view of the main housing and the extension housing with a weld between the insert and the extension housing and a weld between the insert and the main housing, according to an embodiment;

FIG. 11C is a perspective view of the main housing and the extension housing with a weld between the insert and the main housing, according to an embodiment;

FIG. 12 is a cross sectional perspective view of the main housing and the extension housing with the insert being drilled by a drill bit at a pilot hole, according to an embodiment;

FIG. 13A is a perspective view of the main housing and the extension housing with shims being used for alignment, according to an embodiment;

FIG. 13B is a side view of the main housing and the extension housing with shims being used for alignment, according to the embodiment of FIG. 13A;

FIG. 13C is a perspective cross sectional view of the main housing and the extension housing with shims being used for alignment, according to the embodiment of FIG. 13A;

FIG. 14A is a perspective view of the main housing and the extension housing with one fastener for the inserts, according to an embodiment;

FIG. 14B is a perspective cross sectional view of the main housing and the extension housing with one fastener for the inserts, according to the embodiment of FIG. 14A;

FIG. 14C is a perspective view of the main housing and the extension housing with two fasteners for the inserts, according to an embodiment;

FIG. 14D is a perspective cross sectional view of the main housing and the extension housing with two fasteners for the inserts, according to the embodiment of FIG. 14C;

FIG. 15A is a cross sectional perspective view of a main housing and an extension housing with a fully threaded insert, according to an embodiment;

FIG. 15B is a cross sectional perspective view of a main housing an extension housing with a partially threaded insert, according to an embodiment;

FIG. 15C is a cross sectional perspective view of the main housing and the extension housing with the fully threaded insert, according to the embodiment of FIG. 15A;

FIG. 15D is a cross sectional perspective view of the main housing and the extension housing with the partially threaded insert, according to the embodiment of FIG. 15B;

FIG. 15E is a cross sectional side view of the main housing and the extension housing with the fully threaded insert, according to the embodiment of FIG. 15A;

FIG. 15F is a cross sectional side view of the main housing and the extension housing with the partially threaded insert, according to the embodiment of FIG. 15B; and

FIG. 16 is a flow diagram of a method of assembling a motor for an electric submersible pump.

### DETAILED DESCRIPTION

It should be understood at the outset that although illustrative implementations of one or more embodiments are illustrated below, the disclosed systems and methods may be implemented using any number of techniques, whether currently known or not yet in existence. The description that follows includes example systems, methods, techniques, and program flows that embody aspects of the disclosure. However, it is understood that this disclosure may be practiced without these specific details. For brevity, well-known steps, protocols, structures, and techniques have not been shown in detail in order not to obfuscate the description. The disclosure should in no way be limited to the illustrative implementations, drawings, and techniques illustrated below, but may be modified within the scope of the appended claims along with their full scope of equivalents.

As used herein the terms “uphole”, “upwell”, “above”, “top”, and the like refer directionally in a wellbore towards the surface, while the terms “downhole”, “downwell”, “below”, “bottom”, and the like refer directionally in a wellbore towards the toe of the wellbore (e.g. the end of the wellbore distally away from the surface), as persons of skill will understand. Orientation terms “upstream” and “downstream” are defined relative to the direction of flow of fluid, for example relative to flow of well fluid in the well. As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

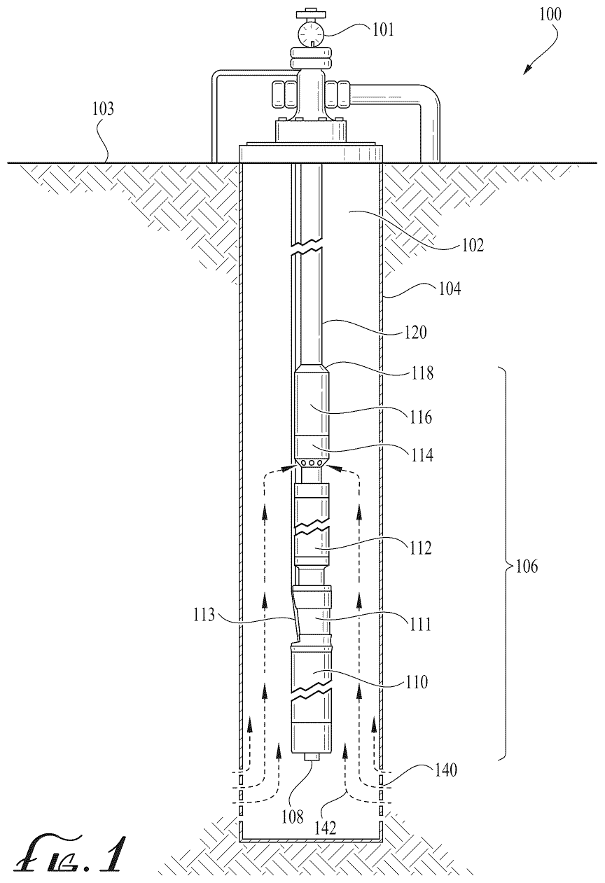

Referring to FIG. 1, an exemplary producing well environment 100 is described. In an embodiment, the environment 100 comprises a wellhead 101 above a wellbore 102 located at the surface 103. A casing 104 is provided within the wellbore 102.

An exemplary electric submersible pump (ESP) 106 may be deployed downhole in a well within the casing 104 and may comprise an optional sensor unit 108, an electric motor assembly 110 which may include a motor head 111, a seal unit 112, an electric power cable 113, a pump intake 114, a centrifugal pump 116, and a pump outlet 118 that couples the centrifugal pump 116 to a production tubing 120. The centrifugal pump 116 may be operatively coupled to the motor assembly 110 by a shaft. In an embodiment, the ESP 106 may employ radial and thrust bearings in several places, for example in the electric motor assembly 110, in the seal unit 112, and/or in the centrifugal pump 116. In an embodiment, the ESP 106 can comprise a gas separator that may employ one or more radial or thrust bearings. The motor head 111 may couple the electric motor assembly 110 to the seal unit 112. The electric power cable 113 may connect to a source of electric power at the surface 103 and to the electric motor assembly 110, for example being configured to provide power from the source of electric power at the surface 103 to the electric motor assembly 110.

In operation, the casing 104 may be pierced by perforations 140, and reservoir fluid 142 may flow through the perforations 140 into the wellbore 102. The fluid 142 may flow downstream in an annulus formed between the casing 104 and the ESP 106, may be drawn into the pump intake 114, may be pumped by the centrifugal pump 116, and may be lifted through the production tubing 120 to the wellhead 101 to be produced at the surface 103. The fluid 142 may comprise hydrocarbons such as oil and/or gas, water, or both hydrocarbons and water.

While the example illustrated in FIG. 1 relates to land-based subterranean wells, similar ESP systems can be used in a subsea environment and/or may be used in subterranean environments located on offshore platforms, drill ships, semi-submersibles, drilling barges, etc. And while the wellbore is shown in FIG. 1 as being approximately vertical, in other embodiments, the wellbore may be horizontal, deviated, or any other type of well. Also, while the pump of the ESP is described with respect to FIG. 1 as a centrifugal pump, other types of pumps (a progressive cavity pump, any other type of pump suitable for the system, or combinations thereof) may be used instead.

In some embodiments, an anti-rotation feature that provides resistance to torque while fixed in place is provided. A method of equipment recovery involving the anti-rotation feature may allow damage free re-opening of the connection.

In some embodiments, a series of one or more features is produced (e.g. machined) at a suitable interface between the tubular threaded components (e.g. motor housings). This feature may be a milled slot, drilled hole, or any other suitable shape. The feature may intersect with both components of the connection. An insert (e.g. a key of any length) whose size and shape interfaces with the produced feature may be inserted into the said produced feature. The fit between insert (e.g. key) and produced feature (e.g. slot) may be such that it holds in place, temporarily or permanently. The presence of the insert(s) may act to prevent relative rotation at the interface between the connected components. The insert can then be fixed in place (e.g. by using a small weld or bolted feature) to connect between either or both connection components. The two sides of the connection may be advantageously, rigidly joined by the insert, which may be easy to remove but also can be sacrificed when re-opening the connection. There may also be a feature in the insert that can assist with its removal when releasing the connection. An example of this is (but not limited to) a pilot hole through the pin, that can be used to guide a drill through the pin to remove it to waste, freeing the connection. Alternative embodiments involve other methods of holding the insert in place, examples of which are (but not limited to) deformation of components by peening or interference fit, use of other joining techniques (e.g. brazing, bonding, cold welding, boundary interspersion), addition of an external band around the connection, etc. To assist in maintaining the straightness of the connection, shims can be used to correct the alignment of the mating surfaces as the connection is tightened. The shims may be removed once the connection has been fixed in place.

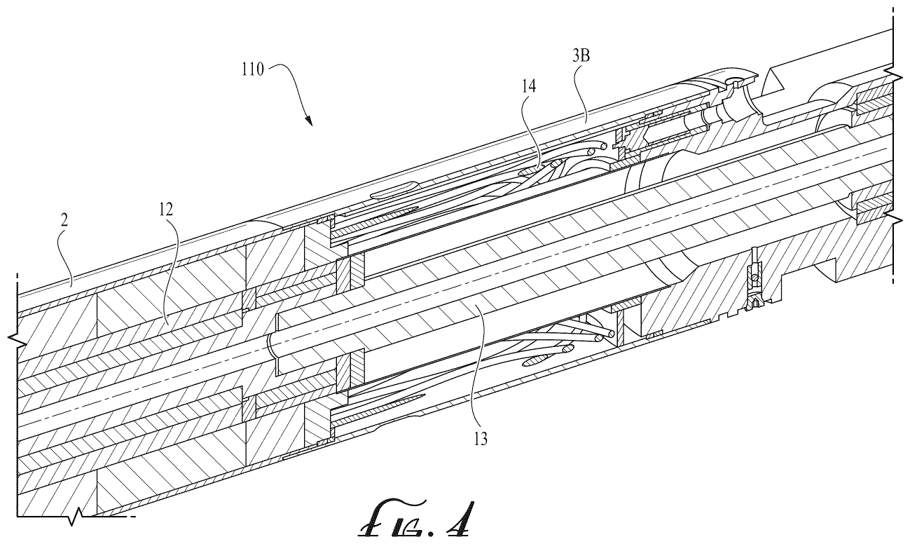

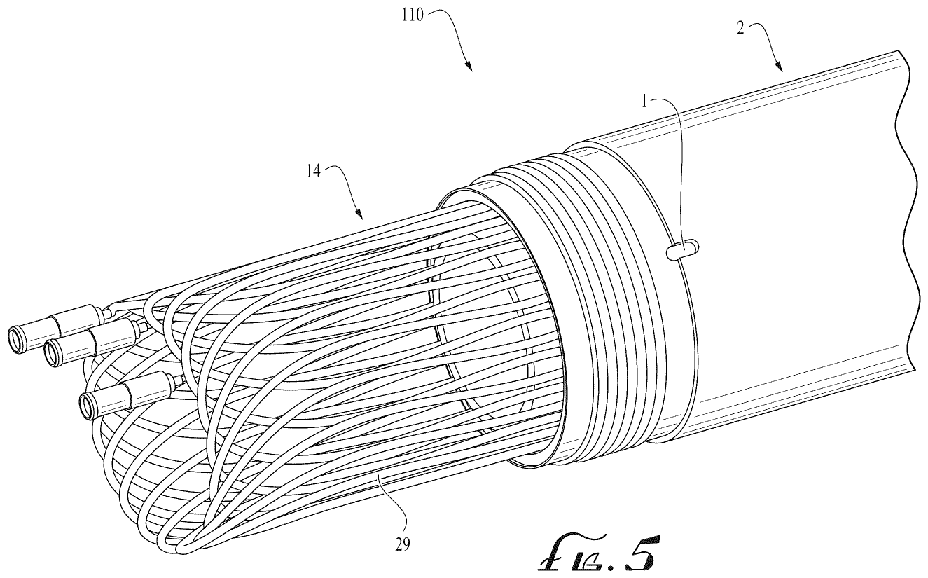

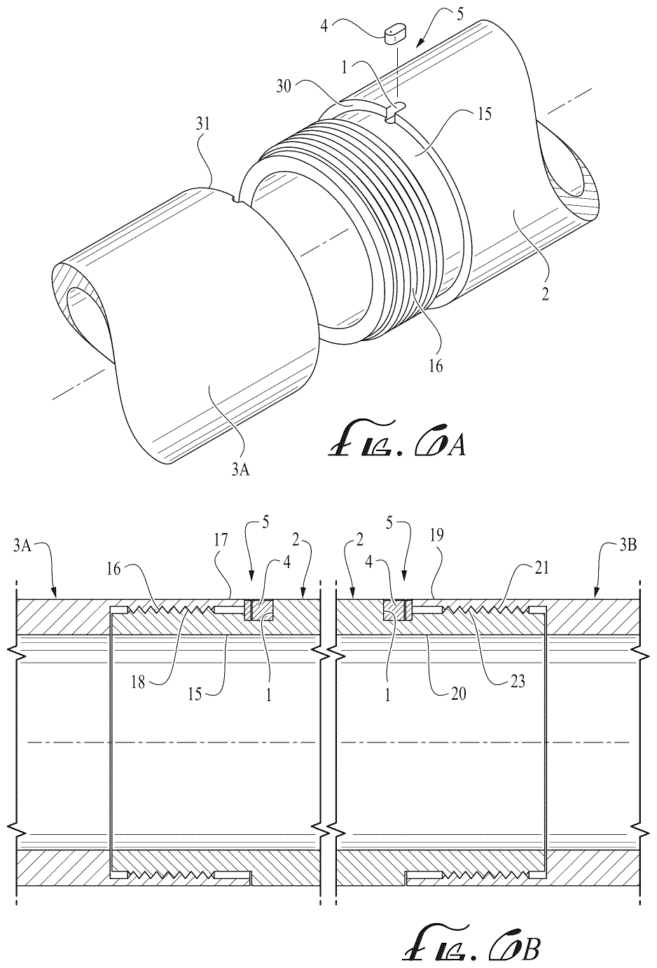

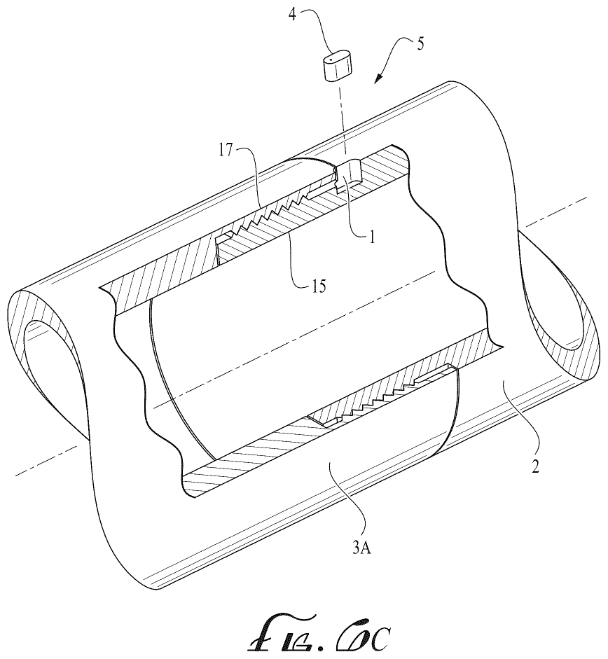

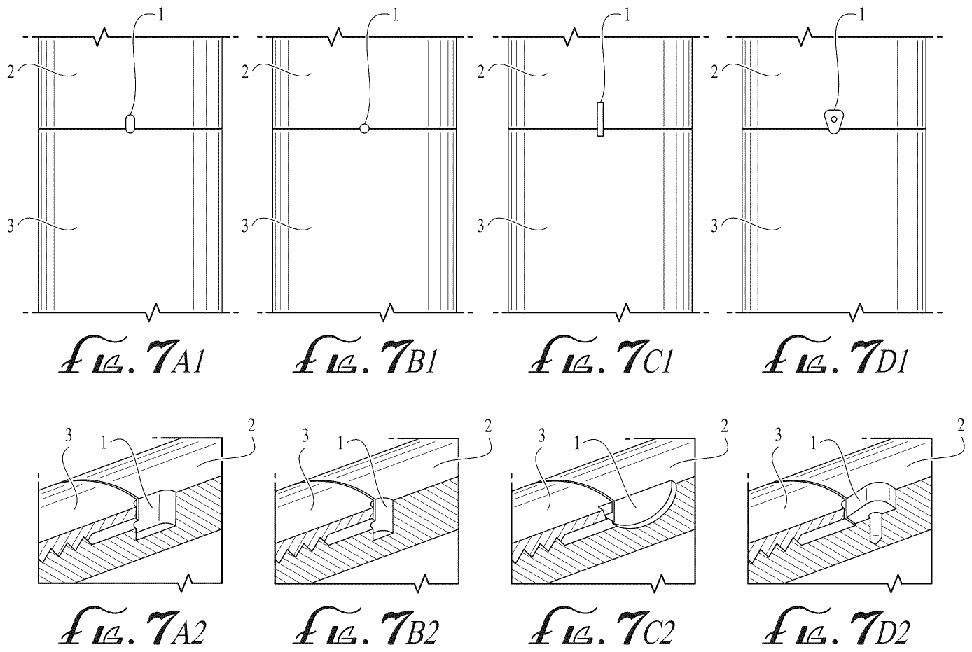

Referring to FIG. 6, an exemplary method may include a series of one or more recesses 1 being produced (e.g. machined) at a suitable interface between the main housing 2 and the extension housing 3 (e.g. motor housings). This recess 1 may be a circular hole, an axially disposed slot, or any other suitable shape (e.g. horizontally milled groove, spark-eroded shape, etc.) (see FIG. 7). The location and depth of the cut may be selected to ensure that the joint's physical arrangement is maintained to fulfil its intended purpose (e.g. to maintain compression on a sealing element). The recess 1 may intersect with both the main housing 2 and extension housing 3. Referring to FIG. 8, the exact position of the recess 1 may vary. For example, it may be set based on the geometry of the components and the required resistance to torque.

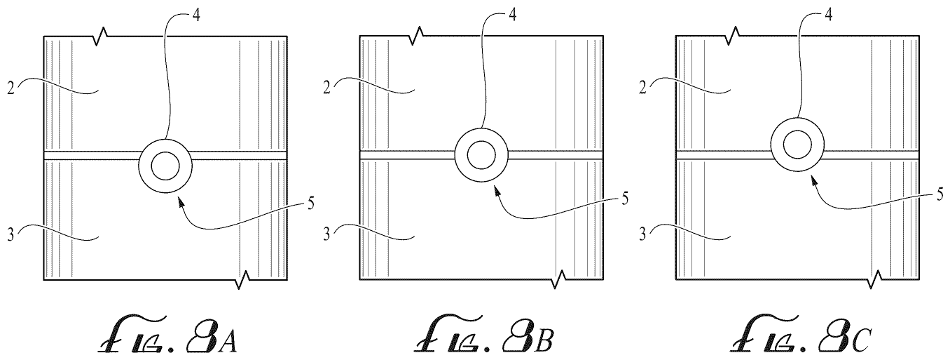

Referring to FIG. 9, an insert 4 (e.g. a locking component, a key, pin or grooved dowel) whose size and shape interfaces with (e.g., corresponds to) the produced recess 1, may be inserted into the produced recess 1. The fit between insert 4 (e.g. key) and produced recess 1 (e.g. slot) may be such that the insert 4 is held in place temporarily or permanently. The fit between the insert 4 and produced recess 1 may also ensure that the desired level of torque can be transmitted across the joint. The presence of the insert(s) 4 may act to prevent relative rotation between the main housing 2 and the extension housings 3.

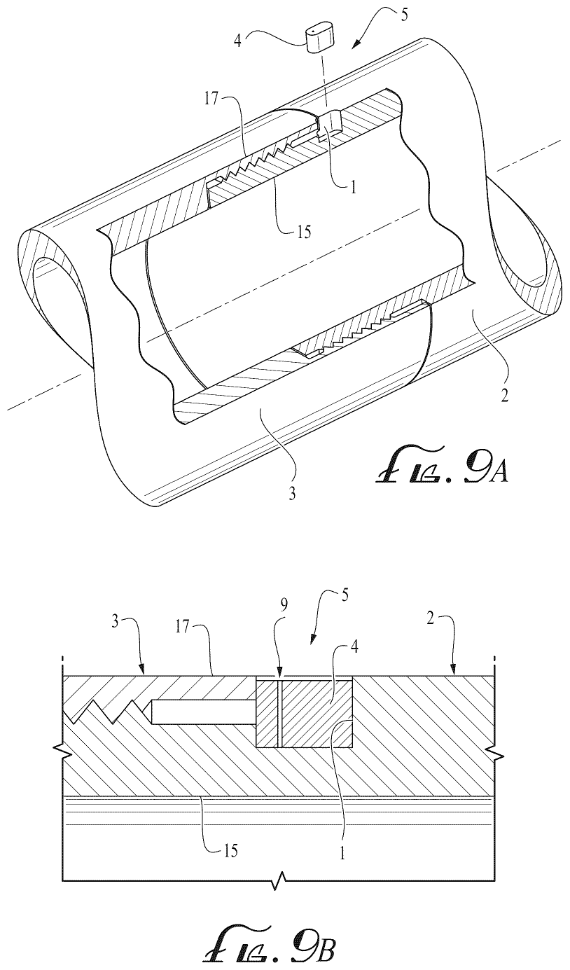

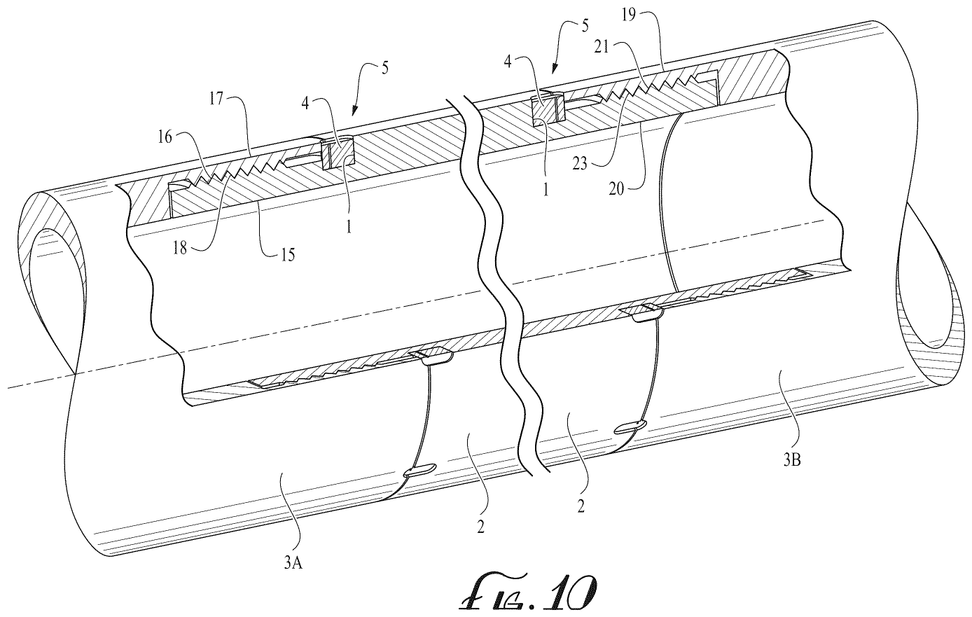

Referring to FIG. 10, in cases where the torque capacity of a single produced recess 1 and insert 4 is insufficient, multiple anti-rotation features 5 (each comprising a produced recess 1 and a corresponding insert 4) can be placed around the joint between the main housing 2 and the extension housing 3. Referring to FIG. 11, the insert 4 can then be fixed in place (e.g. by using a small weld 7) to either or both the main housing 2 and extension housing 3, the advantage being that the two sides of the connection are rigidly joined by a sacrificial insert 4 that is easier to remove in order to re-open the connection. Referring to FIG. 12, there may also be a feature into the insert 4 that assists with its removal when releasing the connection. A non-limiting example is a pilot hole 9 through the insert 4, that can be used to guide a drill bit 8 through the insert 4 to remove it to waste, thus freeing the connection.

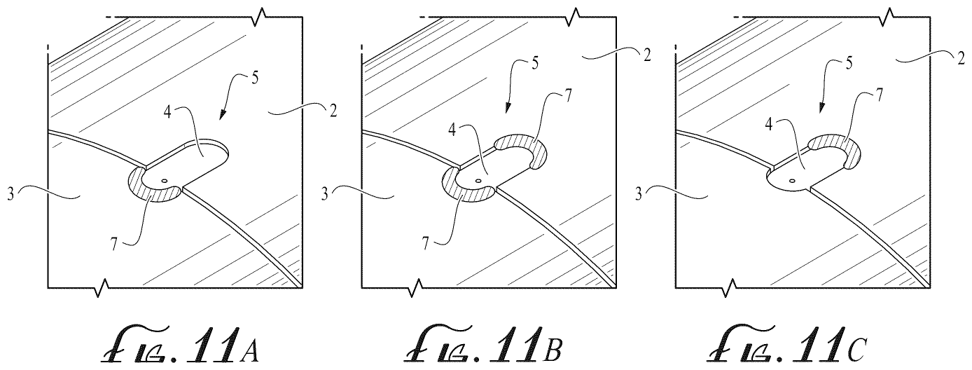

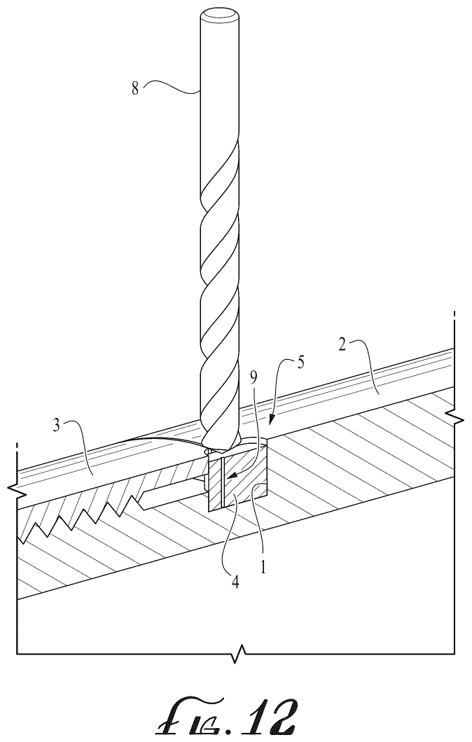

Referring to FIG. 13, in case the threads connecting the housings 2, 3 do not satisfy housing axial alignment requirements when the housing joint is tightened, shims 10 may be introduced to contact the mating housings'2, 3 end faces 30, 31 and minutely adjust their alignment. Careful selection of the shims'10 thickness and position around the circumference of the joint may bias the housings'2, 3 alignment when the joint is closed and fastening torque applied, advantageously bringing the joint back within tolerance. Once the main housing 2 and the extension housing 3 have been fixed in place, the shims 10 may be removed or the excess material may be trimmed.

In various embodiments, other methods may be used to hold the insert 4 in place. Examples of which are (but not limited to) deformation of components by peening or interference fit, use of other joining techniques (e.g. brazing, bonding, cold welding, boundary interspersion), addition of an external band around the connection, etc.

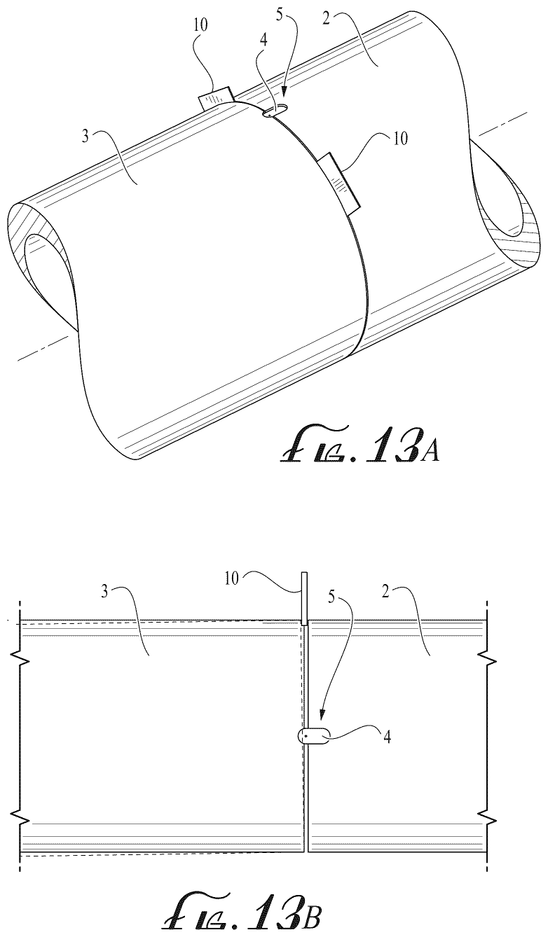

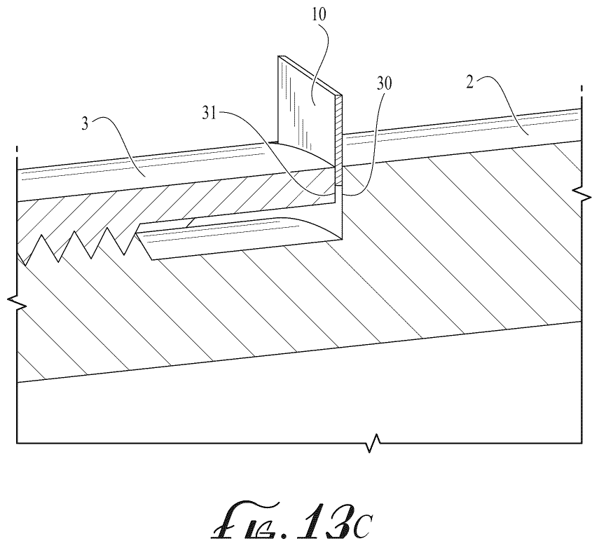

In some embodiments, separate threaded fasteners are used to retain the insert 4 in place. For example, referring to FIGS. 14A and 14B, a single threaded fastener 11 may be positioned to retain the insert 4. In another example, referring to FIGS. 14C and 14D, a pair of threaded fasteners 11 may be positioned to retain the insert 4. Any number of threaded fasteners 11 may be positioned to retain the insert 4. The threaded fasteners 11 may be used in combination with techniques to prevent unintentional loosening due to vibration, (e.g. lock washer, thread-locking compound, residual-torque thread profile, residual-torque thread insert, etc.).

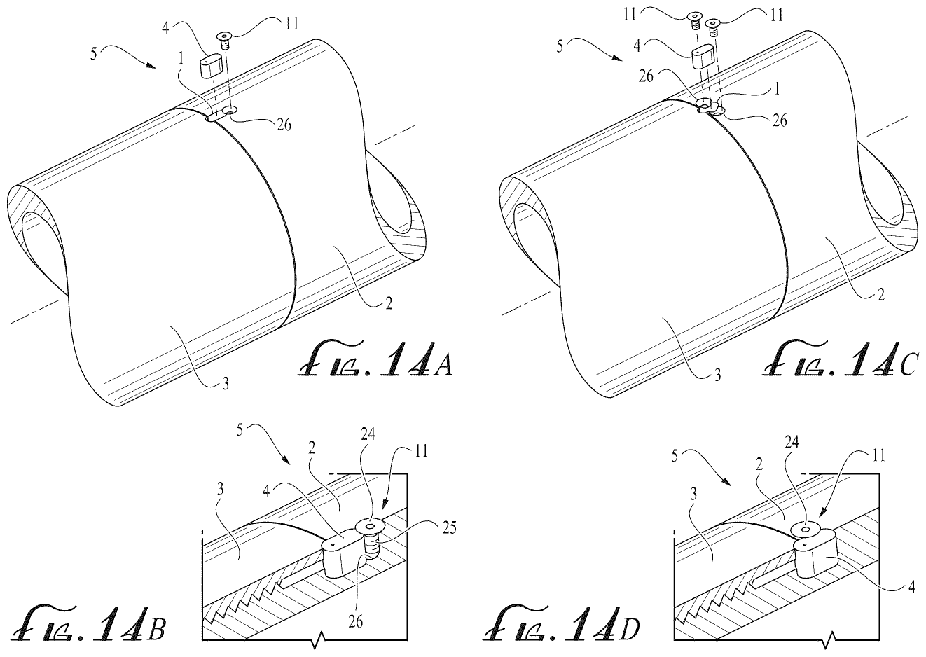

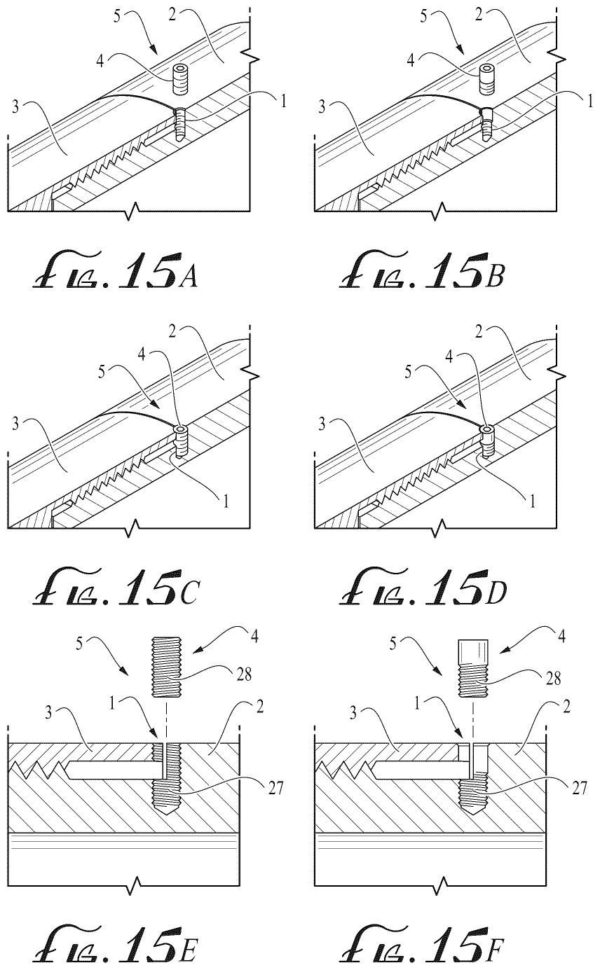

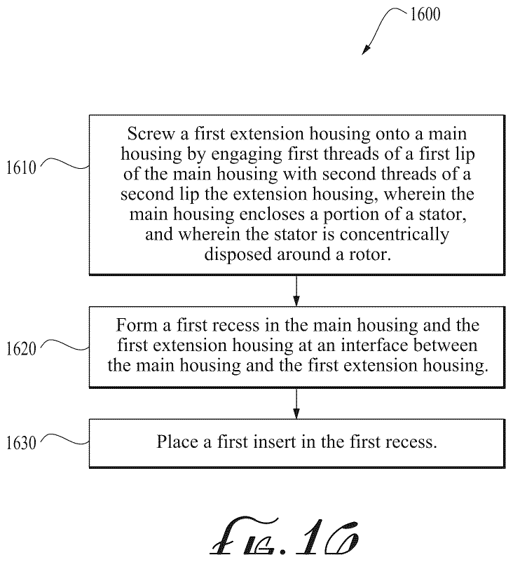

Referring to FIG. 15, the insert 4 may be threaded, where space and geometry permits, directly into the main housing 2 and the extension housing 3. The female threaded portion of the recess 1 may be whole or partial, with the male threaded portion of the insert 4 being whole or partial to match. Referring to FIG. 8, the center point position of the insert 4 may be at any distance from the joint line such that at least a portion of the insert 4 engages with both the main housing 2 and the extension housing 3, according to the level of anti-rotation torque resistance desired.

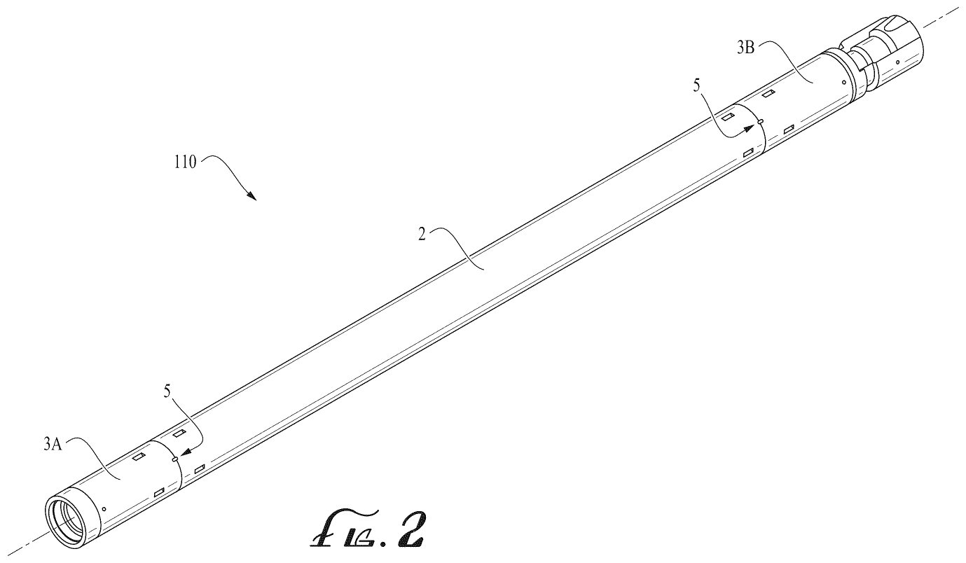

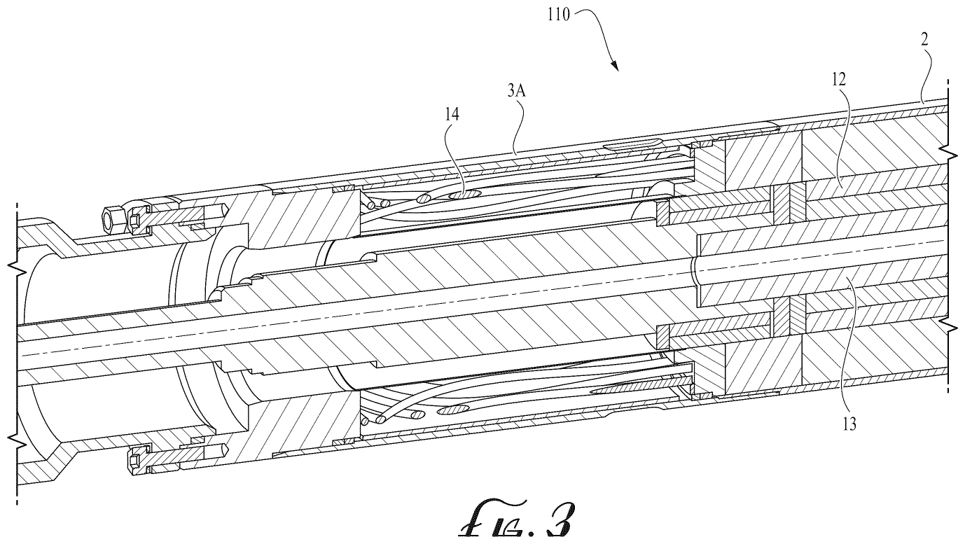

Referring to FIGS. 1-4, 6, and 9-10, a motor 110 for an electric submersible pump 106 may include a rotor 12 (e.g., affixed to a shaft 13), a stator 14 concentrically disposed around the rotor 12, and a main housing 2 comprising a first lip 15 having first threads 16. The main housing 2 may enclose a portion of the stator 14. The motor 110 may further include a first extension housing 3A comprising a second lip 17 having second threads 18. The first threads 16 may engage the second threads 18 to mate the first extension housing 3A to the main housing 2. A first recess 1 may be formed in the main housing 2 and the first extension housing 3A at an interface between the main housing 2 and the first extension housing 3A. The motor 110 may further include a first insert 4 disposed in the first recess 1. The purpose of the extension housings 3A,3B may be to allow windings 29 at the end of the stator 14 to be installed (see FIG. 5). The first extension housing 3A may cover one end of the stator 14 and the second extension housing 3B may cover the other end of the stator 14. The shaft 13 may drive the centrifugal pump 116 (see FIG. 1).

The motor 110 may further include a second insert 4 (e.g., right insert 4 of FIG. 6) and a second extension housing 3B comprising a third lip 19 having third threads 23. The main housing 2 may include a fourth lip fourth lip 20 having fourth threads 21. The fourth threads 21 may engage the third threads 23 to mate the second extension housing 3A to the main housing 2. A second recess 1 (e.g., right recess 1 of FIG. 6) may be formed in the main housing 2 and the second extension housing 3A at an interface between the main housing 2 and the second extension housing 3A. The second insert 4 may be disposed in the second recess 1. The first threads 16 may be male threads, for example, that are disposed on an outer circumferential surface of the first lip 15. The second threads 18 may be female threads, for example, that are disposed on an inner circumferential surface of the second lip 17. The third threads 23 may be female threads, for example, that are disposed on an inner circumferential surface of the third lip 19. The fourth threads 21 may be male threads, for example, that are disposed on an outer circumferential surface of the fourth lip 20. The second lip 17 may be concentrically disposed around the first lip 15. The third lip 19 may be concentrically disposed around the fourth lip 20. There may be a seal between the first lip 15 and the second lip 17. There may be a seal between the third lip 19 and the fourth lip 20. The outer circumferential surface of the second lip 17 may be flush with the outer circumferential surface of the main housing 2. The inner circumferential surface of the first lip 15 may be flush with the inner circumferential surface of the first housing 3A.

In some embodiments (see FIG. 10), a third recess 1 is formed in the main housing 2 and the first extension housing 3A at the interface between the main housing 2 and the first extension housing 3A. The third insert 4 may be disposed in the third recess 1. A fourth recess 1 may be formed in the main housing 2 and the second extension housing 3B at the interface between the main housing 2 and the second extension housing 3B. The fourth insert 4 may be disposed in the fourth recess 1. Any suitable number of inserts 4 may be present at the interface between the main housing 2 and the first extension housing 3A and/or the main housing 2 and the second extension housing 3B. For example, there may be 1, 2, 3, 4, 5, 6, 7, 8, 9, 10, or more inserts 4 at the interface. A first pilot hole 9 may extend through the insert 4, and a second pilot hole 9 may extend through the insert 4. That is, the pilot hole 9 may extend from an outer surface of the insert 4 to an inner surface of the insert 4. The pilot hole 9 may be used to guide a drill bit or other tool for destructive removal of the insert 4.

The first recess 1 and the second recess 1 may each comprises an ovular (see FIG. 7A), circular (see FIG. 7B), rectangular (see FIG. 7C), or triangular cross section (see FIG. 7D). Referring to FIG. 11, the first recess 1 may be welded to either one or both of the main housing 2 and the first extension housing 3, and the second recess 1 may be welded to either one or both of the main housing 2 and the second extension housing 3. In some embodiments, the insert 4 is ovular (e.g., oval-shaped, capsule-shaped, or pill-shaped), and the welds are made on any edge of the insert 4.

Referring to FIG. 14, the threaded shaft 25 of the fastener 11 may engage a threaded hole 26 in the main housing 2. There may be means of securing the fastener 11 from coming out, e.g., insert, threaded locking, etc. The head 24 may cover at least part of the first insert 4. In some embodiments, the threaded shaft 25 is formed in the main housing 2 and opens to the recess 1. In some embodiments, the threaded shaft 25 contacts the insert 4. The fastener 11 may help prevent the insert 4 from backing out of the recess 1. In some embodiments, there are two threaded fasteners 11 each disposed in a threaded hole 26 on opposite sides of the insert 4.

Referring to FIG. 15, the first recess 1 may include third threads 27 (e.g., female threads). The first insert 4 may include fourth threads 28 (e.g., male threads). The third threads 27 may engage the fourth threads 28. In some embodiments, the first insert 4 is fully threaded. In some embodiments, the first insert 4 may be partially threaded. For example, the insert 4 may be a set screw.

Referring to FIGS. 8A and 8C, the first insert 4 may be disposed off-center from the interface between the main housing 2 and the first extension housing 3. For example, in FIG. 8A, the center of the insert 4 (and also the first recess 1) is disposed closer to the extension housing 3. In FIG. 8C, the center of the insert 4 (and also the first recess 1) is disposed closer to the main housing 2. Referring to FIG. 13, one or more shims 10 may be disposed between the main housing 2 and the first extension housing 3.

A method of assembling an electric submersible pump may include coupling the motor 110 to a seal unit 112; coupling the seal unit 112 to the pump intake 114; and coupling the pump intake 114 to a centrifugal pump 116. A method of lifting fluid in a wellbore may include running an electric submersible pump 106 comprising the motor 110 into a wellbore 102; and providing electric power to the motor 110.

Referring to FIG. 16, a method 1600 of assembling a motor for an electric submersible pump may include the step 1610 of screwing a first extension housing onto a main housing by engaging first threads of a first lip of the main housing with second threads of a second lip of the extension housing, wherein the main housing encloses a portion of a stator, and wherein the stator is concentrically disposed around a rotor; the step 1620 of forming (e.g., machining) a first recess in the main housing and the first extension housing at an interface between the main housing and the first extension housing; and the step 1630 of placing a first insert in the first recess. These method steps may be performed in order.

The method 1600 may further include screwing a second extension housing onto the main housing by engaging third threads of a third lip of the second extension housing with fourth threads of a fourth lip of the main housing; forming (e.g., machining) a second recess in the main housing and the second extension housing at an interface between the main housing and the second extension housing; and placing a second insert into the second recess. The first threads may be male threads. The second threads may be female threads. The third threads may be female threads. The fourth threads may be male threads. The method 1600 may further include forming (e.g., machining) a third recess in the main housing and the first extension housing at the interface between the main housing and the first extension housing; placing a third insert in the third recess; forming (e.g., machining) a fourth recess in the main housing and the second extension housing at the interface between the main housing and the second extension housing; and placing the fourth insert in the fourth recess. The method 1600 may further include comprising drilling the first insert to waste (e.g., destructively removing the first insert) by drilling through a pilot hole of the first insert (e.g., using a pilot hole in the first insert to guide the bit of a drill). The method 1600 may further include (e.g., after drilling the first insert to waste), forming (e.g., machining) a second recess in the main housing and the first extension housing at the interface between the main housing and the first extension housing, and placing a second insert (e.g., a replacement insert) in the second recess. The replacement insert may be identical to or different from the first insert before it was destroyed.

The screwing of the first extension housing onto the main housing may include aligning the main housing with the first extension housing by placing one or more shims between the main housing and the first extension housing. For example, screwing the first extension housing onto the main housing, eccentricity may be measured. In response to the degree of eccentricity exceeding a threshold, the first extension housing may be at least partially unscrewed to allow the shims to be placed between the first extension housing and the main housing. After the first extension housing is screwed back onto the main housing, eccentricity may be measured again. This process may be repeated until the degree of eccentricity is less than the threshold.

The system and method of the present disclosure may present the advantage of increasing the torque resistance of a threaded joint to a level that is not possible by merely increasing the torque applied to thread. The torque capacity of the connection may be further increased by adding more locking features per interface. This may present a practical method of removal by employing a sacrificial element, e.g., the insert. The aim is to not damage the recess, but simply remove the insert material. The recess may not need to be reformed and may only need a new insert to be assembled. The connection can be re-made with the same level of torque resistance by choosing new positions for the instances of the recesses. The torque resistance of the joint can be achieved independently of operator. The increased torque capacity of connections may lead to increased reliability of a separable joint. In some embodiments, vibration resistance may be added to threaded joints. The system and method of the present disclosure may also present the advantage in that low-profile housing cross sections can be used because no collars are required. The system and method of the present disclosure may also contribute to sustainability as it presents a cost-effective method of opening a connection, making re-use of individual components and recovering of the whole machine possible. It may lead to increased reliability by reducing the variability of operator involvement.

### Additional Disclosure

The following are non-limiting, specific embodiments in accordance with the present disclosure:
In a first embodiment, a motor for an electric submersible pump comprises a rotor; a stator concentrically disposed around the rotor; a main housing comprising a first lip having first threads, wherein the main housing encloses a portion of the stator; a first extension housing comprising a second lip having second threads, wherein the first threads engage the second threads to mate the first extension housing to the main housing, and wherein a first recess is formed in the main housing and the first extension housing at an interface between the main housing and the first extension housing; and a first insert disposed in the first recess.
A second embodiment can include the motor of the first embodiment, further comprising a second insert and a second extension housing comprising a third lip having third threads, wherein the main housing further comprises a fourth lip having fourth threads, the fourth threads engage the third threads to mate the second extension housing to the main housing, a second recess is formed in the main housing and the second extension housing at an interface between the main housing and the second extension housing, and the second insert is disposed in the second recess.
A third embodiment can include the motor of the first or second embodiments, wherein the first threads are male, the second threads are female, the third threads are female, and the fourth threads are male.
A fourth embodiment can include the motor of any of the first through third embodiments, further comprising a third insert and a fourth insert, wherein a third recess is formed in the main housing and the first extension housing at the interface between the main housing and the first extension housing, the third insert is disposed in the third recess, a fourth recess is formed in the main housing and the second extension housing at the interface between the main housing and the second extension housing, and the fourth insert is disposed in the fourth recess.
A fifth embodiment can include the motor of any of the first through fourth embodiments, wherein the first recess and the second recess each comprises an ovular, circular, rectangular, or triangular cross section.
A sixth embodiment can include the motor of any of the first through fifth embodiments, wherein a pilot hole extends through the first insert.
A seventh embodiment can include the motor of any of the first through sixth embodiments, wherein the first recess is welded to either one or both of the main housing and the first extension housing, and the second recess is welded to either one or both of the main housing and the second extension housing.
An eighth embodiment can include the motor of any of the first through seventh embodiments, further comprising a fastener having a head and a threaded shaft, wherein the threaded shaft engages a threaded hole in the main housing, and wherein the head covers at least part of the first insert.
A ninth embodiment can include the motor of any of the first through eighth embodiments, wherein the first recess comprises third threads, the first insert comprises fourth threads, and the third threads engage the fourth threads.
A tenth embodiment can include the motor of any of the first through ninth embodiments, wherein the first insert is disposed off-center from the interface between the main housing and the first extension housing.
An eleventh embodiment can include the motor of any of the first through tenth embodiments, wherein one or more shims are disposed between the main housing and the first extension housing.
In a twelfth embodiment, a method of assembling an electric submersible pump, comprises coupling the motor of claim 1 to a seal unit; coupling the seal unit to a pump intake; and coupling the pump intake to a centrifugal pump.
In a thirteenth embodiment, a method of lifting fluid in a wellbore, comprises running an electric submersible pump comprising the motor of claim 1 into a wellbore; and providing electric power to the motor.
In a fourteenth embodiment, a method of assembling a motor for an electric submersible pump, comprises screwing a first extension housing onto a main housing by engaging first threads of a first lip of the main housing with second threads of a second lip of the first extension housing, wherein the main housing encloses a portion of a stator, and wherein the stator is concentrically disposed around a rotor; forming a first recess in the main housing and the first extension housing at an interface between the main housing and the first extension housing; and placing a first insert in the first recess.
A fifteenth embodiment can include the method of the fourteenth embodiment, further comprising: screwing a second extension housing onto the main housing by engaging third threads of a third lip of the second extension housing with fourth threads of a fourth lip of the main housing; forming a second recess in the main housing and the second extension housing at an interface between the main housing and the second extension housing; and placing a second insert into the second recess.
A sixteenth embodiment can include the method of the fourteenth or fifteenth embodiments, wherein the first threads are male, the second threads are female, the third threads are female, and the fourth threads are male.
A seventeenth embodiment can include the method of any of the fourteenth through sixteenth embodiments, further comprising: forming a third recess in the main housing and the first extension housing at the interface between the main housing and the first extension housing; placing a third insert in the third recess; forming a fourth recess in the main housing and the second extension housing at the interface between the main housing and the second extension housing; and placing a fourth insert in the fourth recess.
An eighteenth embodiment can include the method of any of the fourteenth through seventeenth embodiments, further comprising drilling the first insert to waste by drilling through a pilot hole of the first insert.
A nineteenth embodiment can include the method of any of the fourteenth through eighteenth embodiments, further comprising, after the drilling of the first insert to waste, forming a second recess in the main housing and the first extension housing at the interface between the main housing and the first extension housing, and placing a second insert into the second recess.
A twentieth embodiment can include the method of any of the fourteenth through nineteenth embodiments, wherein the screwing of the first extension housing onto the main housing comprises aligning/straightening the main housing with the first extension housing by placing one or more shims between the main housing and the first extension housing.

While embodiments have been shown and described, modifications thereof can be made by one skilled in the art without departing from the spirit and teachings of this disclosure. The embodiments described herein are exemplary only and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations. For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ-Rₗ), wherein k is a variable ranging from 1 percent to 100 percent with a 1 percent increment, i.e., k is 1 percent, 2 percent, 3 percent, 4 percent, 5 percent . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Disclosure of a singular element should be understood to provide support for a plurality of the element. It is contemplated that elements of the present disclosure may be duplicated in any suitable quantity.

Use of broader terms such as comprises, includes, having, etc. should be understood to provide support for narrower terms such as consisting of, consisting essentially of, comprised substantially of, etc. The use of terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. Any discussion of a reference herein is not an admission that it is prior art. Any disclosures of all patents, patent applications, and/or publications cited herein are hereby incorporated by reference, to the extent that they provide exemplary, procedural, or other details supplementary to those set forth herein.

As used herein, terms such as parallel, perpendicular, vertical, horizontal, and coincident are not meant to mean exactly parallel, exactly perpendicular, exactly vertical, exactly horizontal, and exactly coincident. Rather, those terms are intended to mean what those of ordinary skill in the art would recognize as parallel, perpendicular, vertical, horizontal, and coincident. Those and similar terms may cover a structural configuration even when there is some imperfection, variation, or deviation from an exact relationship.

As used herein, the term “or” does not require selection of only one element. Thus, the phrase “A or B” is satisfied by either one or both elements from the set {A, B}. A clause that recites “A or B” can be infringed with only one of the listed items, both of the listed items, multiples of the listed items, and one or both of the listed items and another item not listed. The phrase “A, B, or C” is satisfied by any one or any combination of any two or more from the set {A, B, C}. A clause that recites “A, B, or C” can be infringed with only one of the listed items, multiples of the listed items, and one or more of the items from the list and another item not listed.

As used herein, the article “a” means “one or more.” As used herein, the article “an” means “one or more.” As used herein, the article “the” when referring to a singular noun means “the one or more.” Thus, the phrase “an element” means “one or more elements;” and the phrase “the element” means “the one or more elements.”

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A motor for an electric submersible pump, comprising:
a rotor;
a stator concentrically disposed around the rotor;
a main housing comprising a first lip having first threads, wherein the main housing encloses a portion of the stator;
a first extension housing comprising a second lip having second threads, wherein the first threads engage the second threads to mate the first extension housing to the main housing, and wherein a first recess is formed in the main housing and the first extension housing at an interface between the main housing and the first extension housing; and
a first insert disposed in the first recess.

2. The motor of claim 1, further comprising a second insert and a second extension housing comprising a third lip having third threads, wherein
the main housing further comprises a fourth lip having fourth threads,
the fourth threads engage the third threads to mate the second extension housing to the main housing,
a second recess is formed in the main housing and the second extension housing at an interface between the main housing and the second extension housing, and
the second insert is disposed in the second recess.

3. The motor of claim 2, wherein
the first threads are male,
the second threads are female,
the third threads are female, and
the fourth threads are male.

4. The motor of claim 2, further comprising a third insert and a fourth insert, wherein
a third recess is formed in the main housing and the first extension housing at the interface between the main housing and the first extension housing,
the third insert is disposed in the third recess,
a fourth recess is formed in the main housing and the second extension housing at the interface between the main housing and the second extension housing, and
the fourth insert is disposed in the fourth recess.

5. The motor of claim 2, wherein the first recess and the second recess each comprises an ovular, circular, rectangular, or triangular cross section.

6. The motor of claim 1, wherein a pilot hole extends through the first insert.

7. The motor of claim 2, wherein
the first recess is welded to either one or both of the main housing and the first extension housing, and
the second recess is welded to either one or both of the main housing and the second extension housing.

8. The motor of claim 1, further comprising a fastener having a head and a threaded shaft, wherein the threaded shaft engages a threaded hole in the main housing, and wherein the head covers at least part of the first insert.

9. The motor of claim 1, wherein
the first recess comprises third threads,
the first insert comprises fourth threads, and
the third threads engage the fourth threads.

10. The motor of claim 1, wherein the first insert is disposed off-center from the interface between the main housing and the first extension housing.

11. The motor of claim 1, wherein one or more shims are disposed between the main housing and the first extension housing.

12. A method of assembling an electric submersible pump, comprising:
coupling the motor of claim 1 to a seal unit;
coupling the seal unit to a pump intake; and
coupling the pump intake to a centrifugal pump.

13. A method of lifting fluid in a wellbore, comprising:
running an electric submersible pump comprising the motor of claim 1 into a wellbore; and
providing electric power to the motor.

14. A method of assembling a motor for an electric submersible pump, comprising:
screwing a first extension housing onto a main housing by engaging first threads of a first lip of the main housing with second threads of a second lip of the first extension housing, wherein the main housing encloses a portion of a stator, and wherein the stator is concentrically disposed around a rotor;
forming a first recess in the main housing and the first extension housing at an interface between the main housing and the first extension housing; and
placing a first insert in the first recess.

15. The method of claim 14, further comprising:
screwing a second extension housing onto the main housing by engaging third threads of a third lip of the second extension housing with fourth threads of a fourth lip of the main housing;
forming a second recess in the main housing and the second extension housing at an interface between the main housing and the second extension housing; and
placing a second insert into the second recess.

16. The method of claim 15, wherein
the first threads are male,
the second threads are female,
the third threads are female, and
the fourth threads are male.

17. The method of claim 15, further comprising:
forming a third recess in the main housing and the first extension housing at the interface between the main housing and the first extension housing;
placing a third insert in the third recess;
forming a fourth recess in the main housing and the second extension housing at the interface between the main housing and the second extension housing; and
placing a fourth insert in the fourth recess.

18. The method of claim 14, further comprising drilling the first insert to waste by drilling through a pilot hole of the first insert.

19. The method of claim 18, further comprising, after the drilling of the first insert to waste, forming a second recess in the main housing and the first extension housing at the interface between the main housing and the first extension housing, and placing a second insert into the second recess.

20. The method of claim 14, wherein the screwing of the first extension housing onto the main housing comprises straightening the main housing with the first extension housing by placing one or more shims between the main housing and the first extension housing.

21. The motor of claim 1, wherein the first recess is one of at least three recesses at the interface, and the first insert is one of at least three inserts respectively disposed in the recesses.

22. The method of claim 14, wherein the first recess is one of at least three recesses formed at the interface, and the first insert is one of at least three inserts respectively placed in the recesses.
